(19) United States
(12) Patent Application Publication
(10) Pub. No.: US 2008/0273088 A1
(43) Pub. Date: Nov. 6, 2008

(54) INTELLIGENT SURVEILLANCE SYSTEM AND METHOD FOR INTEGRATED EVENT BASED SURVEILLANCE

(76) Inventors: Chiao-Fe Shu, Scarsdale, NY (US); Arun Hampapur, Norwalk, CT (US); Zuoxuan Lu, Yorktown Heights, NY (US); Ying-Li Tian, Yorktown Heights, NY (US); Lisa Marie Brown, Pleasantville, NY (US); Andrew William Senior, New York, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/132,872

(22) Filed: Jun. 4, 2008

Related U.S. Application Data
(63) Continuation of application No. 11/455,251, filed on Jun. 16, 2006.

(51) Int. Cl. H04N 7/18; G08B 13/00; G06F 17/40

(52) U.S. Cl. 348/154; 340/541; 707/104.1; 348/E07.085

(57) ABSTRACT

A surveillance system and method includes a plurality of sensors configured to monitor an environment. A plurality of analytic engines is associated with each of the plurality of sensors. The plurality of analytic engines employs different technologies and is configured to analyze input from the sensors to determine whether an event has occurred in a respective technology. A unifying data model is configured to cross correlate detected events from the different technologies to gain integrated situation awareness across the different technologies.

### RELATED APPLICATION INFORMATION

This application is a Continuation application of co-pending U.S. patent application Ser. No. 11/455,251 filed Jun. 16, 2006, incorporated herein by reference in its entirety.

### BACKGROUND

1. Technical Field

The present invention relates to surveillance systems and methods and more particularly to an integrated surveillance system that employs multiple technologies integrated to provide improved results.

2. Description of the Related Art

Smart Surveillance is the use of computer vision and pattern recognition technologies to analyze information from situated sensors. The analysis of the sensor data generates events of interest in the environment. For example, an event of interest at a departure drop off area in an airport includes “cars that stop in the loading zone for extended periods of time”. As smart surveillance technologies have matured, they have typically been deployed as isolated applications which provide a particular set of functionalities. Isolated applications while delivering some degree of value to the users, do not comprehensively address the security requirements.

Therefore, a more comprehensive approach is needed to address security needs for different applications. A further need exists for a flexible way to implement such applications.

### SUMMARY

A surveillance system and method includes a plurality of sensors configured to monitor an environment. A plurality of analytic engines is associated with each of the plurality of sensors. The plurality of analytic engines employs different technologies and is configured to analyze input from the sensors to determine whether an event has occurred in a respective technology. A unifying data model is configured to cross correlate detected events from the different technologies to gain integrated situation awareness across the different technologies.

Another surveillance system includes a plurality of cameras configured to monitor an environment and a plurality of analytic engines associated with each camera. The plurality of analytic engines employs recognition and motion detection technologies to analyze input from the cameras to determine whether an event has occurred in a respective technology in accordance with defined event criteria. A unifying data model is configured to cross correlate detected events from different technologies by indexing events in a database to gain integrated situation awareness across the different technologies.

A surveillance method includes analyzing sensor input from a plurality of sensors using multiple analytical technologies to detect events in the sensor input, and cross correlating the events in a unifying data model such that the cross correlating provides an integrated situation awareness across the multiple analytical technologies.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an illustrative surveillance system employing a unifying data model which integrates events from a plurality of sources;

FIG. 2 is a diagram showing a unifying data model (time line data model) in accordance with an illustrative embodiment;

FIG. 3 is a block diagram showing an IBM S3 system adapted in accordance with a surveillance system in accordance with present principles;

FIG. 4 is a block diagram showing unifying data model types in accordance with an illustrative embodiment;

FIG. 5 is exemplary extensible markup language (XML) code for tracking an object in accordance with present principles;

FIG. 6 is a plan view layout of an environment monitored during an implementation of the surveillance system in accordance with present principles;

FIG. 7 is a series of images taken by a camera showing illustrative results of the implementation described in FIG. 6; and

FIG. 8 is a flow diagram showing a surveillance method in accordance with present principles.

### DETAILED DESCRIPTION OF PREFERRED EMBODIMENTS

Embodiments in accordance with present principles include an intelligent surveillance system and method. Smart surveillance technology becomes one important component in security infrastructures, where system architecture assumes a high level of importance. The present disclosure considers an example of smart surveillance in an airport environment. This example is presented to demonstrate present principles and should not be construed as limiting as other applications are contemplated.

In accordance with one embodiment, a threat model is provided for airports and used to derive the security requirements and constraints. These requirements are used to motivate an open-standards based architecture for surveillance. Aspects of this architecture and its implementation have been implemented using an IB® S3™ smart surveillance system. Demonstrative results from a pilot deployment are also presented.

It is to be understood that cameras and sensors may be used interchangeably throughout the specification and claims. For purposes of this document sensors include cameras and vice versa.

Embodiments of the present invention can take the form of an entirely hardware embodiment, an entirely software embodiment or an embodiment including both hardware and software elements. In a preferred embodiment, the present invention is implemented in a combination of hardware and software. The software may include but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

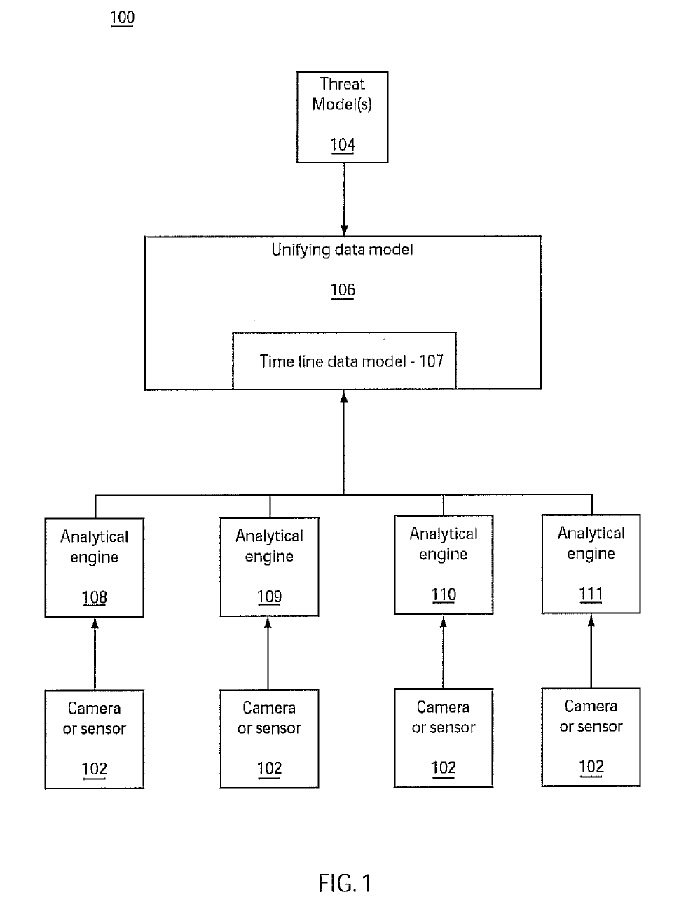

Referring now to the drawings in which like numerals represent the same or similar elements and initially to FIG. 1, a system 100 is illustratively depicted in accordance with one embodiment. System 100 illustratively includes four cameras or sensors 102; however, any number of cameras or sensors may be employed.

In the airport security application, an objective is to use advanced surveillance and access control technologies to enhance the level of security at an airport. The analysis of requirements for any security application starts with the enumeration of a threat model 104. The following is an example threat model 104 for an airport. In reality, developing a detailed threat model 104 needs a deep understanding of the environment and operational procedures in that environment. In this illustrative example, the threat model 104 considers the following:

1) Outsider Threat: This is the case where unauthorized personnel get access to the airport facilities and perform malicious actions, which may include: A) Perimeter breach: Here the attacker breaches the airport perimeter and performs malicious acts within the airport premises. B) Distance Attacks: Here the attacker does not gain physical access to the airport premises but uses a projectile device to attack the airport.

2) Customer Threat: This is the case where customers or users of the airport who have been permitted to access the airport facility perform malicious acts. A) Access to Restricted Areas: A user could get access to a restricted area through tailgating and perform malicious acts within the restricted area. B) Malicious acts in passenger areas: A user who has been cleared through airport security may perform malicious acts like abandoning packages, etc.

3) Insider Threat: This is the case where employees or contractors who are authorized to perform operations in the airport perform malicious acts. A) Insider Acts: Once an employee has access to the facility, they may perform a wide variety of malicious acts. B) Tailgating: An employee may either willfully or unknowingly allow unauthorized personnel to gain access to the facility.

Each of these categories of threats covers a very wide range of potential attack models. A comprehensive security plan would use various technological and process components to achieve the goal of enhanced security.

The following requirements are derived from the above threat models 104: 1) Provide real time perimeter breach detection capabilities. 2) Provide real time awareness of various activities that are occurring within the perimeter of the airport. 3) Provide real time detection of unauthorized access to secure areas through tailgating. 4) Provide real-time awareness of activities (both customers and employees) within airport buildings customers. 5) Provide event based investigation capabilities.

One approach to addressing these requirements would be to put in place specific systems which address, each of these requirements. For example, a video based behavior analyses system could address the perimeter breach detection and activity awareness requirement. A video based tailgating detection system could address the tailgating requirement. A face recognition capture and recognition system could address the requirement of monitoring passengers entering the terminal. A license plate recognition system could be used to recognize license plates of cars parked in the parking lot. However, this approach will not address one of the most important requirements of enhancing security, which is the ability to cross correlate information across different threat models. For example, if an investigator needs to associate a particular suspicious passenger with a license plate and the passengers association to any airport employees, the above approach of having independent systems will preclude such an investigation.

A unifying data model 106 is created based on the threat models 104 for integrated situation awareness. Enabling the event cross correlation preferably employs the unifying data model 106. A time line based data model 107 which can represent events detected by multiple analytical engines 108-111 is employed and will be described in greater detail below.

One motivation behind this employing the unifying model 106 is that all events in the real world occur at a particular time. Hence as long as the events are logged with an associated timestamp, the events from multiple analytical engines 108-111 can be correlated to achieve integrated situation awareness. Each application will have different types of sensors (102) and event analysis technologies (in engine 108-111) implemented as part of their security infrastructure. E.g., airport camera #1 may be using face recognition and video behavioral analysis, while airport camera #2 may be using video behavior analysis, license plate recognition and ground radar tracking. The data model 106 is sufficient to accommodate both of these applications.

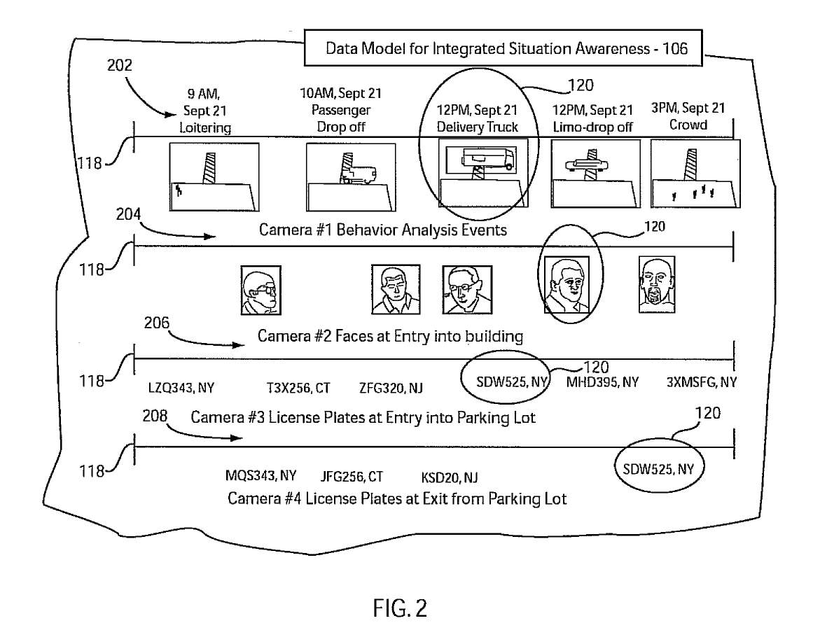

Referring to FIG. 2, a unifying model 106 e.g., a time line data model 107, is shown with layered event annotations 118 generated by multiple analytic engines. Encircled events 120 show how the data model enables cross correlation, giving the analyst the ability to understand when a particular vehicle arrived and left the facility and the likely driver of the truck. Model 106 shows additional types of event detection technology modeled as time lines for each event detection type. This data model 106 can have as many instances of event generators as needed by the application environment. In the application depicted, model 106 includes an application with four cameras. Time line 202 corresponds to camera #1, which has a wide angle view of a parking lot. This camera is analyzed by a typical video based behavioral analysis system, which is capable of detecting moving object events, including classification of objects. Time line 204 corresponds to camera #2, which is placed at the entrance of the building where people enter the building. Camera #2 is analyzed by a system capable of detecting face images from the video. Time line 206 and time line 208, respectively correspond to camera #3 and camera #4. Camera #3 and camera #4 are placed at the entrance and exit to the parking lot. Camera #3 and camera #4 are analyzed for license plates numbers. The license plate recognition technology, generates the license plate number along with the state information.

Data model 106 enables the cross correlation of information. For example, using the license plate recognition results, it is easy to identify when a particular vehicle entered and exited the parking lot. This time interval can be used to select the vehicles which drove thru the parking lot during that interval and people who entered the building during the same interval, thus allowing an investigator to gain integrated situation awareness across multiple analytical capabilities.

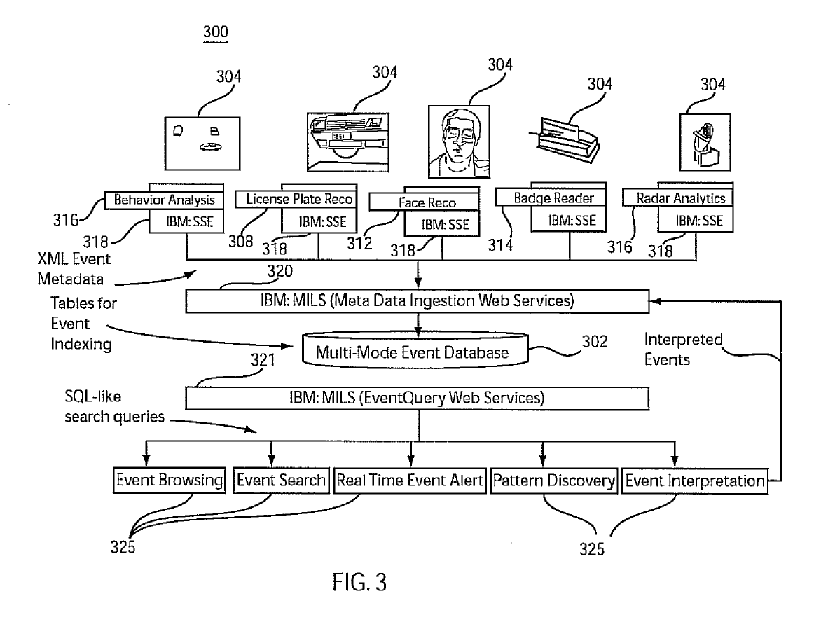

Referring to FIG. 3, an IBM® Smart Surveillance System (S3)™ architecture 300 is illustratively shown adapted to implement a time line data model in accordance with present principles. The IBM S3 system architecture is adapted to satisfy two principles. 1) Openness: The system permits integration of both analysis and retrieval software made by third parties. In one embodiment, the system is designed using approved standards and commercial off-the-shelf (COTS) components. 2) Extensibility: The system should have internal structures and interfaces that will permit for the functionality of the system to be extended over a period of time.

The architecture 300 enables the use of multiple independently developed event analysis technologies in a common framework. The events from all these technologies are cross indexed into a common repository or a multi-modal event database 302 allowing for correlation across multiple sensors 304 and event types.

The example system 300 includes the following illustrative technologies integrated into a single system. License plate recognition technology 308 may be deployed at the entrance to a facility where technology 308 catalogs a license plate of each of the arriving and departing vehicles. Behavior analysis technology 310 detects and tracks moving objects and classifies the objects into a number of predefined categories. Technology 310 could be deployed on various cameras overlooking a parking lot, a perimeter, inside a facility, etc. Face detection/recognition technology 312 may be deployed at entry ways to capture and recognize faces. Badge reading technology 314 may be employed to read badges. Radar analytics technology 316 may be employed to determine the presences or objects. Events from access control technologies can also be integrated into the system 300.

The events from all the above surveillance technologies are cross indexed into a single repository 302. In such a repository 302, a simple time range query across the modalities will extract license plate information, vehicle appearance information, badge information and face appearance information, thus permitting an analyst to easily correlate these attributes. The architecture 300 includes one or more smart surveillance engines (SSEs) 318, which house event detection technologies. Architecture 300 further includes Middleware for Large Scale Surveillance (MILS) 320 and 321, which provides infrastructure for indexing, retrieving and managing event meta-data.

Data Flow Description: The following is a high level description of data flow in architecture 300. Sensor data from a variety of sensors 304 is processed in the SSEs 318. Each SSE 318 can generate real-time alerts and generic event meta-data. The meta-data generated by the SSE 318 may be represented using XML. The XML documents include a set of fields which are common to all engines and others which are specific to the particular type of analysis being performed by the engine 318. The meta-data generated by the SSEs is transferred to a backend MILS system 320. This may be accomplished via the use of, e.g., web services data ingest application program interfaces (APIs) provided by MILS 320. The XML meta-data is received by MILS 320 and indexed into predefined tables in the database 302. This may be accomplished using the DB2™ XML extender, if an IBM® DB2™ database is employed. This permits for fast searching using primary keys. MILS 321 provides a number of query and retrieval services 325 based on the types of meta-data available in the database. The retrieval services 325 may includes, e.g., event browsing, event search, real time event alert, pattern discovery event interpretation, etc.

Each event has a reference to the original media resource (i.e. a link to the video file), thus allowing the user to view the video associated with a retrieved event.

System 300 provides an open and extensible architecture for smart video surveillance. SSEs 318 preferably provide a plug and play framework for video analytics. The event meta-data generated by the engines 318 may be sent to the database 302 as XML files. Web services API's in MILS 320 permit for easy integration and extensibility of the meta-data. Various applications 325 like event browsing, real time alerts, etc. may use structure query language (SQL) or similar query language through web services interfaces to access the event meta-data from the data base 302.

The smart surveillance engine (SSE) 318 may be implemented as a C++ based framework for performing real-time event analysis. This engine 318 is capable of supporting a variety of video/image analysis technologies and other types of sensor analysis technologies. SSE 318 provides at least the following support functionalities for the core analysis components. The support functionalities are provided to programmers or users through a plurality of interfaces 328 employed by the SSE 318. These interfaces are illustratively described below.

Standard plug-in interfaces are provided. Any event analysis component which complies with the interfaces defined by the SSE 318 can be plugged into the SSE 318. The definitions include standard ways of passing data into the analysis components and standard ways of getting the results from the analysis components. Extensible meta-data interfaces are provided. The SSE 318 provides meta-data extensibility. For example, consider a behavior analysis application which uses detection and tracking technology. Assume that the default meta-data generated by this component is object trajectory and size. If the designer now wishes to add, color of the object into the metadata, the SSE 318 enables this by providing a way to extend the creation of the appropriate XML structures for transmission to the backend (MILS) system 320.

Real-time alerts are highly application dependent, while a person loitering may require an alert in one application, the absence of a guard at a specified location may require an alert in a different application. The SSE provides an easy real-time alert interfaces mechanism for developers to plug-in for application specific alerts. SSE 318 provides standard ways of accessing event-meta data in memory and standardized ways of generating and transmitting alerts to the backend (MILS) system 320.

In many applications, users will need the use of multiple basic real-time alerts in a spatio-temporal sequence to compose an event that is relevant in the user's application context. The SSE 318 provides a simple mechanism for composing compound alerts via compound alert interfaces. In many applications, the real-time event meta-data and alerts are used to actuate alarms, visualize positions of objects on an integrated display and control cameras to get better surveillance data. The SSE 318 provides developers with an easy way to plug-in actuation modules which can be driven from both the basic event meta-data and by user defined alerts using real-time actuation interfaces.

Using database communication interfaces, the SSE 318 also hides the complexity of transmitting information from the analysis engines to the database 302 by providing simple calls to initiate the transfer of information.

The IBM Middleware for Large Scale Surveillance (MILS) 320 and 321 may include a J2EE™ frame work built around IBM's DB2™ and IBM WebSphere™ application server platforms. MILS 320 supports the indexing and retrieval of spatio-temporal event meta. MILS 320 also provides analysis engines with the following support functionalities via standard web services interfaces using XML documents.

MILS 320/321 provides meta-data ingestion services. These are web services calls which allow an engine to ingest events into the MILS 320/321 system. There are two categories of ingestion services. 1) Index Ingestion Services: This permits for the ingestion of meta-data that is searchable through SQL like queries. The meta-data ingested through this service is indexed into tables which permit content based searches (provided by MILS 320). 2) Event Ingestion Services: This permits for the ingestion of events detected in the SSE 318 (provided by MILS 321). For example, a loitering alert that is detected can be transmitted to the backend along with several parameters of the alert. These events can also be retrieved by the user but only by the limited set of attributes provided by the event parameters.

The MILS 320 and/or 321 provides schema management services. Schema management services are web services which permit a developer to manage their own meta-data schema. A developer can create a new schema or extend the base MILS schema to accommodate the metadata produced by their analytical engine. In addition, system management services are provided by the MILS 320 and/or 321.

The schema management services of MILS 320/321 provide the ability to add a new type of analytics to enhance situation awareness through cross correlation. E.g., a threat model (104) of a monitored environment is dynamic and can change over time. Thus, it is important to permit a surveillance system to add new types of analytics and cross correlate the existing analytics with the new analytics. To add/register a new type sensor and/or analytics to increase situation awareness, a developer can develop new analytics and plug them into an SSE 318, and employ MILS's schema management service to register new intelligent tags generated by the new SSE analytics. After the registration process, the data generated by the new analytics can immediately available for cross correlating with existing index data.

System management services provide a number of facilities needed to manage a surveillance system including: 1) Camera Management Services These services include the functions of adding or deleting a camera from a MILS system, adding or deleting a map from a MILS system, associating a camera with a specific location on a map, adding or deleting views associated with a camera, assigning a camera to a specific MILS server and a variety of other functionality needed to manage the system. 2) Engine Management Services: These services include functions for starting and stopping an engine associated with a camera, configuring an engine associated with a camera, setting alerts on an engine and other associated functionality. 3) User Management Services These services include adding and deleting users to a system, associating selected cameras to a viewer, associating selected search and event viewing capacities to a user and associating video viewing privilege to a user. 4) Content Based Search Services: These services permit a user to search through an event archive using a plurality of types of queries.

For the content based search services (4), the types of queries may include: A) Search by Time retrieves all events that occurred during a specified time interval. B) Search by Object Presence retrieves the last 100 events from a live system. C) Search by Object Size retrieves events where the maximum object size matches the specified range. D) Search by Object Type retrieves all objects of a specified type. E) Search by Object Speed retrieves all objects moving within a specified velocity range. F) Search by Object Color retrieves all objects within a specified color range. G) Search by Object Location retrieves all objects within a specified bounding box in a camera view. H) Search by Activity Duration retrieves all events with durations within the specified range. I) Composite Search combines one or more of the above capabilities. Other system management services may also be employed.

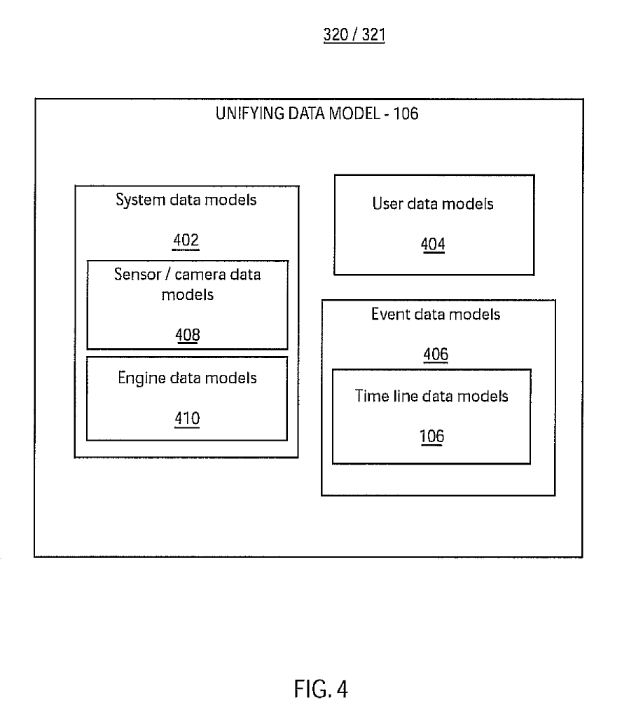

Referring to FIG. 4, MILS system 320/321 has three types of data models, namely, 1) a system data model 402 which captures the specification of a given monitoring system, including details like geographic location of the system, number of cameras, physical layout of the monitored space, etc.; 2) a user data model 404 which models users, privileges and user functionality; and 3) an event data model 406 which captures the events that occur in a specific sensor or zone in the monitored space. Each of these data models is described below.

The system data model 402 has a number of components. These may include a sensor/camera data model 408. The most fundamental component of this data model 408 is a view. A view is defined as some particular placement and configuration (location, orientation, parameters) of a sensor. In the case of a camera, a view would include the values of the pan, tilt and zoom parameters, any lens and camera settings and position of the camera. A fixed camera can have multiple views. The view “Id” may be used as a primary key to distinguish between events being generated by different sensors. A single sensor can have multiple views. Sensors in the same geographical vicinity are grouped into clusters, which are further grouped under a root cluster. There is one root cluster per MILS server 320/321.

Engine data models 410 provide a comprehensive security solution which utilizes a wide range of event detection technologies. The engine data model 410 captures at least some of the following information about the analytical engines: Engine Identifier: A unique identifier assigned to each engine; Engine Type: This denotes the type of analytic being performed by the engine, for example face detection, behavior analysis, LPR, etc.; and Engine Configuration: This captures the configuration parameters for a particular engine.

User data model 404 captures the privileges of a given user. These may include selective access to camera views; selective access to camera/engine configuration and system management functionality; and selective access to search and query functions.

Event data model 406 represents the events that occur within a space that may be monitored by one or more cameras or other sensors. A time line data model 107 (FIG. 2) may be employed as discussed above. The time line data model 107 uses time as a primary synchronization mechanism for events that occur in the real world, which is monitored through sensors. The basic MILS schema allows multiple layers of annotations for a given time span.

The following is a description of one illustrative schema: Event: An event is defined as an interval of time.

StartTime: Time at which the event starts.

Duration: This is the duration of the event. Events with zero duration are permitted, for example snapping a picture or swiping a badge through a reader.

Event ID: This is a unique number which identifies a specific event.

Event Type: This is an event type identifier.

Other descriptors: Every analysis engine can generate its own set of tags. If the tags are basic types, e.g., CHAR, INT, FLOAT, they can be searched using the native search capabilities of the database. However, if the tag is a special type (for example, a color histogram) the developer needs to supply a mechanism for searching the field.

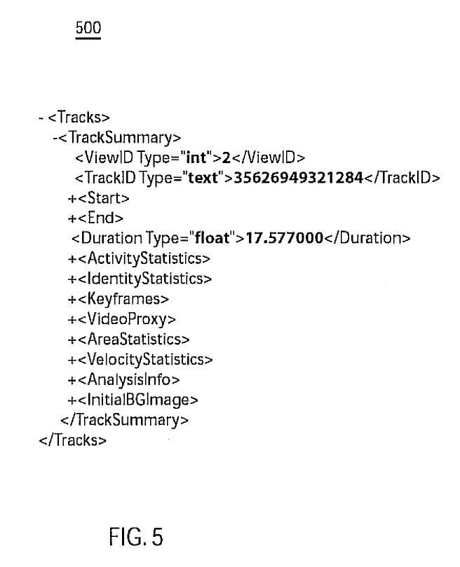

Referring to FIG. 5, a fragment 500 of an XML file describing an object track in a camera is provided to illustrate an exemplary XML structure. The fragment 500 of object track meta-data may be represented in other programming languages other than XML.

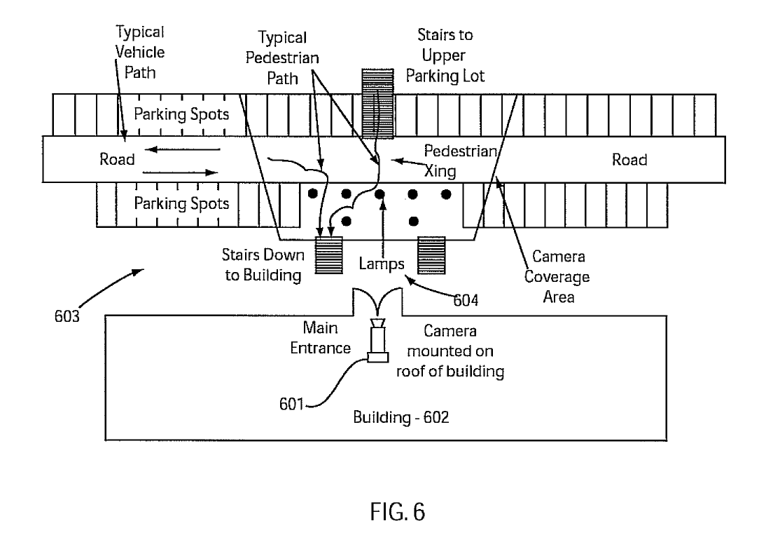

Referring to FIG. 6, a deployment scenario for a camera at the IBM facility in Hawthorne, N.Y. was employed to demonstrate the present embodiments. A camera 601 is situated on a roof of a building 602 and covers part of a parking lot 603 and an entrance plaza 604.

Using camera 601, an event browser was employed to determine event with respect to a region of interest.

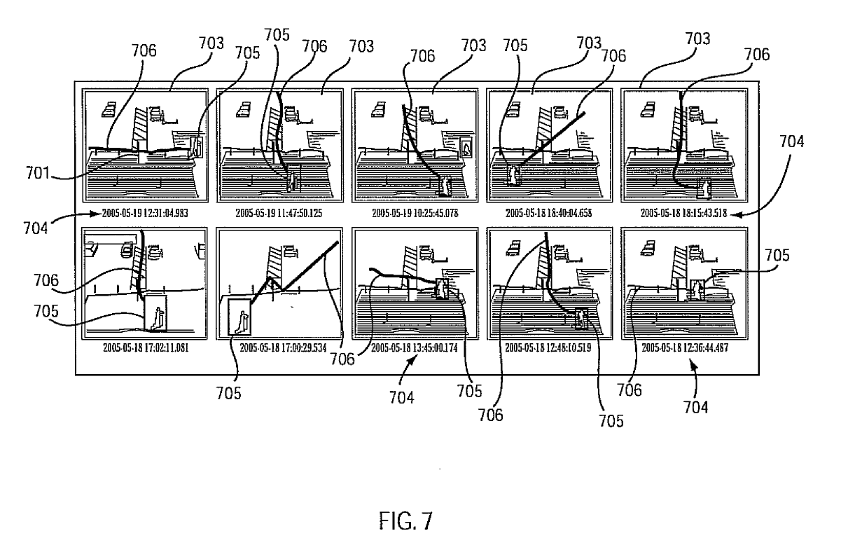

Referring to FIG. 7, selected results from a region of interest query are illustratively shown. The event browser shows a rectangle 701 indicating the users region of interest specification. Each icon 703 represents an event. Events are ordered in reverse chronological order from top left. Each event has a timestamp 704 indicating the time at which the event started. Each icon represents an object of interest (indicated by a box 705) and a trajectory 706 taken by the object. Note the system captures events through the day to night transition. Note that the trajectory 706, in each of the icons, intersects the user's region of interest.

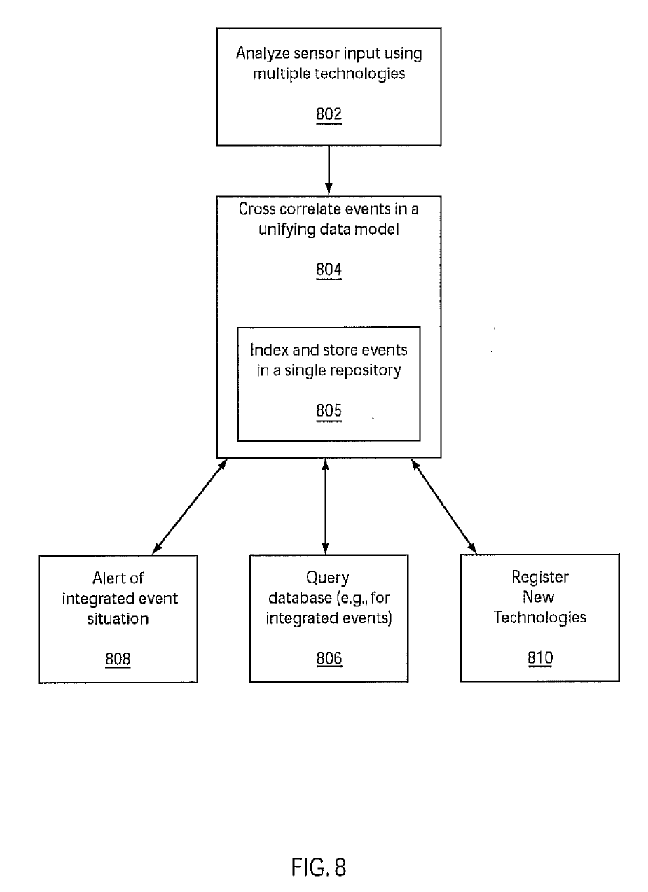

Referring to FIG. 8, a surveillance method in accordance with present principles is illustratively shown. In block 802, sensor input is analyzed from a plurality of sensors using multiple analytical technologies to detect events in the sensor input. Sensor inputs may come from, e.g., a camera, a badge reader, a motion detector, radar, etc. The multiple technologies may include, e.g., a behavior analysis engine, a license plate recognition engine, a face recognition engine, a badge reader engine, a radar analytic engine, etc.

In block 804, the events are cross correlated in a unifying data model such that the cross correlating provides an integrated situation awareness across the multiple analytical technologies. The cross correlating may include correlating events to a time line to associate events to define an integrated event. The cross correlating may include indexing and storing the events in a single repository (e.g., a database) in block 805.

In block 806, a data base can be queried to determine an integrated event that matches the query. This includes employing cross correlated information from a plurality of information technologies and/or sources. In block 808, a user may be alerted of a situation where integrated situation information is combined to trigger an alert.

In block 810, new analytical technologies may be registered. The new analytical technologies can employ model and cross correlate with existing analytical technologies to provide a dynamically configurable surveillance system.

The systems and methods in accordance with present principles provide an open framework for event based surveillance. The systems and methods will make the process of integrating technologies easier. The use of a database to index events opens up a new area of research in context based exploitation of smart surveillance technologies. Additionally, the system will be deployed in a variety of application environments including homeland security, retail, casinos, manufacturing, mobile platform security, etc.

Having described preferred embodiments of an intelligent surveillance system and method for integrated event based surveillance (which are intended to be illustrative and not limiting) it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A surveillance system, comprising:
a plurality of sensors configured to monitor an environment;
a plurality of analytic engines associated with each of the plurality of sensors, the plurality of analytic engines employing different technologies and being configured to analyze input from the sensors to determine whether an event has occurred in a respective technology; and
a unifying data model configured to cross correlate detected events from the different technologies to gain integrated situation awareness across the different technologies.

2. The system as recited in claim 1, wherein the plurality of sensors includes at least one of: a camera, a badge reader, and a motion detector.

3. The system as recited in claim 1, wherein the plurality of analytic engines includes at least one of: a behavior analysis engine, a license plate recognition engine, a face recognition engine, a badge reader engine and a radar analytic engine.

4. The system as recited in claim 1, wherein the unifying data model includes a time line data model which associates events with a time to define an integrated event.

5. The system as recited in claim 1, wherein the unifying data model is based on a threat model that considers potential threats to an environment.

6. The system as recited in claim 1, wherein the system includes a system data model which captures a specification of a monitoring system, a user data model which models users, privileges and user functionality and an event data model which captures events that occur in a monitored space.

7. The system as recited in claim 1, further comprising a database configured to index integrated situation information such that the integrated situation information is searchable by a user.

8. A surveillance system, comprising:
a plurality of cameras configured to monitor an environment;
a plurality of analytic engines associated with each camera, the plurality of analytic engines employing recognition and motion detection technologies to analyze input from the cameras to determine whether an event has occurred in a respective technology in accordance with defined event criteria; and
a unifying data model configured to cross correlate detected events from different technologies by indexing events in a database to gain integrated situation awareness across the different technologies.

9. The system as recited in claim 8, wherein the recognition and motion detection technologies include at least one of: behavior analysis, license plate recognition, a face recognition, a badge reader and ground radar.

10. The system as recited in claim 8, wherein the unifying data model includes a time line data model which associates events with a time to define an integrated event.

11. The system as recited in claim 8, wherein the unifying data model is based on a threat model that considers potential threats to an environment.

12. The system as recited in claim 8, wherein the system includes a system data model which captures a specification of a monitoring system, a user data model which models users, privileges and user functionality and an event data model which captures events that occur in a monitored space.

13. A surveillance method, comprising:
analyzing sensor input from a plurality of sensors using multiple analytical technologies to detect events in the sensor input; and
cross correlating the events in a unifying data model such that the cross correlating provides an integrated situation awareness across the multiple analytical technologies.

14. The method as recited in claim 13, further comprising registering new analytical technologies and cross correlating the new analytical technologies with existing analytical technologies.
analyzing sensor input includes analyzing sensor input from at least one of: a camera, a badge reader, and a motion detector.

15. The method as recited in claim 13, wherein using multiple analytical technologies includes using at least one of: a behavior analysis engine, a license plate recognition engine, a face recognition engine, a badge reader engine and a radar analytic engine.

16. The method as recited in claim 13, wherein cross correlating includes correlating events to a time line to associates events to define an integrated event.

17. The method as recited in claim 13, further comprising querying a data base to determine an integrated event that matches the query.

18. The method as recited in claim 13, wherein the cross correlating the events includes indexing and storing the events in a single repository.

19. The method as recited in claim 13, further comprising alerting a user of a situation where integrated situation information is combined to trigger an alert.

20. A computer program product comprising a computer useable medium including a computer readable program, wherein the computer readable program when executed on a computer causes the computer to perform the steps of:
analyzing sensor input from a plurality of sensors using multiple analytical technologies to detect events in the sensor input; and
cross correlating the events in a unifying data model such that the cross correlating provides an integrated situation awareness across the multiple analytical technologies.
